(19) United States
(12) Patent Application Publication
(10) Pub. No.: US 2026/0318330 A1
(43) Pub. Date: Oct. 15, 2026

(54) FLUID ACTUATOR, AND FLUID POWER CIRCUIT STRUCTURE FOR FLUID ACTUATOR

(71) Applicant: NABTESCO CORPORATION, Tokyo (JP)

(72) Inventors: Koji ITO, Tokyo (JP); Keigo FUTAMATA, Tokyo (JP); Masaharu IWANE, Tokyo (JP); Satoshi ASADA, Tokyo (JP)

(21) Appl. No.: 19/461,130

(22) Filed: Jan. 27, 2026

(30) Foreign Application Priority Data
Mar. 4, 2025 (JP) 2025-033617

(51) Int. Cl. F15B 15/26; F15B 15/14

(52) U.S. Cl. CPC F15B 15/26; F15B 15/1447

(57) ABSTRACT

A fluid actuator includes: a key lock switchable between a key locked state where movement of a piston unit relative to a cylinder is restricted and a key released state where the movement of the piston unit relative to the cylinder is allowed; a ram lock movable between a locked position where transition of the key lock from the key locked state to the key released state is restricted and a released position where the transition of the key lock from the key locked state to the key released state is allowed; and a locking piston provided in an interior space of the piston unit, and being configured to push the ram lock from the released position to the locked position. A space where a first end of the locking piston is exposed is connected to a space where a second end of the locking piston is exposed.

### CROSS-REFERENCE TO RELATED APPLICATIONS

This application is based on and claims the benefit of priority from Japanese Patent Application Serial No. 2025-033617 (filed on Mar. 4, 2025), the contents of which are hereby incorporated by reference in their entirety.

### TECHNICAL FIELD

The present disclosure relates to a fluid actuator and a fluid power circuit structure for a fluid actuator.

### BACKGROUND

Japanese Patent Application Publication No.2006-520880 (“the ‘880 Publication”) discloses a fluid actuator including a cylinder, a piston provided in the cylinder, and a locking mechanism. In the fluid actuator, the locking mechanism can prevent the movement of the piston relative to the cylinder.

The locking mechanism for the fluid actuator as disclosed in the ‘880 Publication is desirably configured to fix and release the piston regardless of the pressure of the working fluid in the fluid actuator.

### SUMMARY

An aspect of the present disclosure provides a fluid actuator including: a piston unit provided in a cylinder to divide an interior space of the cylinder into a first fluid chamber and a second fluid chamber; a key lock configured to be switched between (i) a key locked state where movement of the piston unit relative to the cylinder is restricted and (ii) a key released state where the movement of the piston unit relative to the cylinder is allowed; a ram lock configured to move between (i) a locked position where transition of the key lock from the key locked state to the key released state is restricted and (ii) a released position where the transition of the key lock from the key locked state to the key released state is allowed; and a locking piston provided in an interior space of the piston unit, the locking piston being configured to push the ram lock from the released position to the locked position. A space where a first end of the locking piston is exposed is connected to a space where a second end of the locking piston is exposed.

According to the above configuration, the pressure of the space where the first end of the locking piston is exposed is equal to the pressure of the space where the second end of the locking piston is exposed. Accordingly, when the force exerted by the working fluid in the space where the first end is exposed to bias the locking piston increases, the force exerted by the working fluid in the space where the second end is exposed to bias the locking piston correspondingly increases. This can result in restricting the movement of the locking piston away from the ram lock. Thus, the piston can more reliably remain at a fixed position regardless of the pressure of the working fluid in the fluid actuator.

In the fluid actuator, the interior space of the piston unit may have: a third fluid chamber connected to the second fluid chamber; a fourth fluid chamber connected to the first fluid chamber; a fifth fluid chamber connected to the third fluid chamber; and a communicating channel connecting the third and fourth fluid chambers. When a positive direction refers to a specific direction parallel to a central axis of the piston unit and a negative direction is opposite to the positive direction, the third fluid chamber, the communicating channel, the fourth fluid chamber, and the fifth fluid chamber are arranged in a stated order toward the negative direction. The ram lock may be located inside the third fluid chamber. The locking piston may be inserted into and close the communicating channel, and the locking piston may have an internal channel that establishes communication between the third and fifth fluid chambers.

The fluid actuator may include a spring provided in the fourth fluid chamber, the spring biasing the locking piston toward the positive direction. An outer diameter of the locking piston, an inner diameter of the communicating channel, and an inner diameter of the fifth fluid chamber may be equal.

An aspect of the present disclosure provides a fluid actuator includes: a piston unit provided in a cylinder to divide an interior space of the cylinder into a first fluid chamber and a second fluid chamber; a key lock configured to be switched between (i) a key locked state where movement of the piston unit relative to the cylinder is restricted and (ii) a key released state where the movement of the piston unit relative to the cylinder is allowed; a ram lock configured to move between (i) a locked position where transition of the key lock from the key locked state to the key released state is restricted and (ii) a released position where the transition of the key lock from the key locked state to the key released state is allowed; and a release unit configured to push the ram lock from the locked position toward the released position. A space where a first end of the release unit is exposed is connected to a space where a second end of the release unit is exposed.

According to the above configuration, the pressure of the space where the first end of the release unit is exposed is equal to the pressure of the space where the second end of the release unit is exposed. Accordingly, when the force exerted by the working fluid in the space where the first end is exposed to bias the release unit increases, the force exerted by the working fluid in the space where the second end is exposed to bias the release unit correspondingly increases. Thus, the piston can be more reliably released from the fixed state regardless of the pressure of the working fluid in the fluid actuator.

In the fluid actuator, the cylinder may have: a guide channel connected to the second fluid chamber; a sixth fluid chamber connected to the guide channel; a signal chamber connected to the sixth fluid chamber; and a seventh fluid chamber connected to the signal chamber. The release unit may include: a release rod extending from the second fluid chamber, through the guide channel, the sixth fluid chamber, and the signal chamber, and to the seventh fluid chamber, the release rod being inserted into and closing the guide channel, and the release rod having an internal channel that establishes communication between the second and seventh fluid chambers; and a release piston projecting outward from an outer circumferential surface of the release rod, the release piston separating the sixth fluid chamber and the signal chamber.

In the fluid actuator, the release rod may have: a first portion that is nearer the second fluid chamber than the release piston; and a second portion that is nearer the seventh fluid chamber than the release piston. An outer diameter of the first portion may be greater than an outer diameter of the second portion.

The fluid actuator may include an indicator configured to move, upon movement of the locking piston away from the ram lock, in a direction intersecting a direction of the movement of the locking piston, to protrude beyond an outer circumferential surface of the piston unit.

An aspect of the present disclosure provides a fluid power circuit structure for a fluid actuator, which includes: the fluid actuators described above; a supply channel through which a working fluid is supplied to the fluid actuator; a discharge channel through which the working fluid is discharged from the fluid actuator; and a valve configured to block communication between (i) the fluid actuator and (ii) the supply channel and the discharge channel.

In the above-described fluid power circuit structure, the pressure in the second fluid chamber may rise unintentionally depending on how the fluid channels are connected. The fluid actuators described above can be particularly suitably applied to the fluid power circuit structure relating to the foregoing embodiment, from the perspective that the ram lock can be prevented from moving to the released position accidentally.

### ADVANTAGEOUS EFFECTS

According to the above configuration, the piston can more reliably remain at a fixed position and be released from the fixed state regardless of the pressure of the working fluid in the fluid actuator.

### BRIEF DESCRIPTION OF THE DRAWINGS

FIG. 1 shows the configuration of a fluid power circuit structure for a fluid actuator according to one embodiment.

FIG. 2 is a sectional view of the fluid actuator in a locked state.

FIG. 3 is a sectional view of the fluid actuator in a released state.

FIG. 4 is an enlarged view showing a locking piston of the fluid actuator and its surrounding area.

FIG. 5 is an enlarged view showing a release unit of the fluid actuator and its surrounding area.

### DESCRIPTION OF THE PREFERRED EMBODIMENTS

Embodiments of the present disclosure, which include a liquid actuator and a fluid power circuit structure for a liquid actuator, will be described hereinafter with reference the appended drawings. For simplicity and clarity of the description, the elements shown in the drawings are not necessarily drawn to a fixed scale. The accompanying drawings are merely illustrative of the embodiments of the present disclosure and should not be considered as limitative.

The following detailed description encompasses apparatuses, systems, and methods embodying illustrative embodiments of the present disclosure. The detailed description is merely exemplary in nature and is not intended to limit the embodiments of the disclosure or their application and uses.

### EMBODIMENTS

### Fluid Power Circuit Structure

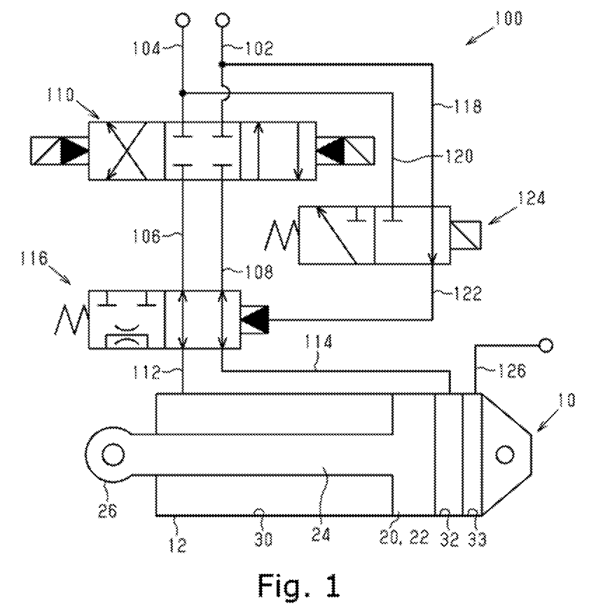

As shown in FIG. 1, a fluid power circuit structure 100 includes a fluid actuator 10. The fluid actuator 10 includes a cylinder 12 and a piston unit 20. The interior space of the fluid actuator 10 includes a first fluid chamber 30, a second fluid chamber 32, and a signal chamber 33. The cylinder 12 has a substantially cylindrical shape.

The piston unit 20 is located inside the cylinder 12. The piston unit 20 has a piston 22, a piston rod 24, and a rod end 26. The piston 22 is located inside the cylinder 12. The piston 22 divides the interior space of the cylinder 12 into the first and second fluid chambers 30 and 32. The piston rod 24 extends from the piston 22 toward the first fluid chamber 30. The portion of the piston rod 24 that includes the end opposite to the piston 22 reaches the outside of the cylinder 12. The rod end 26 is joined to the end of the piston rod 24 that is opposite to the piston 22. Although not shown, the rod end 26 has a device attached, which can be driven by the fluid actuator 10.

In the fluid actuator 10, as the pressure in the first fluid chamber 30 increases, the rod end 26 moves toward the cylinder 12. As the pressure in the second fluid chamber 32 increases, the rod end 26 moves away from the cylinder 12. The detailed structure of the fluid actuator 10 will be described below. In the following description, the pressure of a fluid in an X chamber or in an X channel may be simply referred to as the pressure in the X chamber or in the X channel.

The fluid power circuit structure 100 has a supply channel 102, a discharge channel 104, a first supply and discharge channel 106, a second supply and discharge channel 108, and a supply and discharge valve 110. The supply channel 102 provides a channel through which a working fluid flows to be supplied to the fluid actuator 10. In other words, the supply channel 102 allows the working fluid to be supplied to the fluid actuator 10. The discharge channel 104 provides a channel through which the working fluid flows to be discharged from the fluid actuator 10. In other words, the discharge channel 104 allows the working fluid to be discharged from the fluid actuator 10. The supply channel 102 and the discharge channel 104 are connected to the supply and discharge valve 110. The first and second supply and discharge channels 106 and 108 are connected to the supply and discharge valve 110.

The supply and discharge valve 110 is configured as a flow switch valve. The supply and discharge valve 110 can switch the state of connection between (i) the supply channel 102 and discharge channel 104 and (ii) the first and second supply and discharge channels 106 and 108. Specifically, the supply and discharge valve 110 can be switched to any one of three states: a first connected state, a second connected state, and a closed state.

In the first connected state, the supply and discharge valve 110 establishes connection between the supply channel 102 and the second supply and discharge channel 108, and between the discharge channel 104 and the first supply and discharge channel 106. Therefore, in the first connected state, the working fluid supplied through the supply channel 102 is supplied into the second supply and discharge channel 108. In the first connected state, the working fluid discharged from the fluid actuator 10 flows through the first supply and discharge channel 106 and is discharged into the discharge channel 104.

In the second connected state, the supply and discharge valve 110 establishes connection between the supply channel 102 and the first supply and discharge channel 106, and between the discharge channel 104 and the second supply and discharge channel 108. Therefore, in the second connected state, the working fluid discharged from the fluid actuator 10 flows through the second supply and discharge channel 108 and is discharged into the discharge channel 104. In the second connected state, the working fluid is supplied through the supply channel 102 to be supplied into the first supply and discharge channel 106.

When the supply and discharge valve 110 is in the closed state, the supply channel 102, the discharge channel 104, the first supply and discharge channel 106, and the second supply and discharge channel 108 are all closed. This means that, when the supply and discharge valve 110 is in the closed state, the channel leading to the fluid actuator 10 is independent of the supply channel 102 and discharge channel 104. Placing the supply and discharge valve 110 in the closed state can suspend the supply and discharge of the working fluid to and from the fluid actuator 10. The supply and discharge valve 110 is therefore an example of a valve that can block the communication between (i) the supply and discharge channels 102 and 104 and (ii) the fluid actuator 10. In order to switch the supply and discharge valve 110 from the first connected state to the second connected state, it is first switched from the first connected state to the closed state, and then from the closed state to the second connected state. Similarly, in order to switch the supply and discharge valve 110 from the second connected state to the first connected state, it is temporarily placed in the closed state.

The fluid power circuit structure 100 has a first channel 112, a second channel 114, and a mode valve 116. The first channel 112 is connected to the first fluid chamber 30 of the fluid actuator 10. The second channel 114 is connected to the second fluid chamber 32 of the fluid actuator 10.

The mode valve 116 is connected to the above-described first supply and discharge channel 106 at the side opposite to the supply and discharge valve 110. The mode valve 116 is connected to the above-described second supply and discharge channel 108 at the side opposite to the supply and discharge valve 110. The mode valve 116 can switch the state of connection between (i) the first and second supply and discharge channels 106 and 108, and (ii) the first and second channels 112 and 114. Specifically, the mode valve 116 can switch the connected state between a first state and a second state.

In the first state, the mode valve 116 establishes communication between the first supply and discharge channel 106 and the first channel 112, and between the second supply and discharge channel 108 and the second channel 114. Therefore, when the mode valve 116 is in the first state, the first channel 112 can be connected to the supply channel 102 or the discharge channel 104 via the first supply and discharge channel 106. When the mode valve 116 is in the first state, the second channel 114 can be connected to the supply channel 102 or the discharge channel 104 via the second supply and discharge channel 108.

When the mode valve 116 is in the second state, the first and second supply and discharge channels 106 and 108 are both closed, and the first and second channels 112 and 114 establish communication with each other via an orifice. The orifice provides resistance to the flow of the working fluid between the first and second channels 112 and 114.

When the mode valve 116 is in the second state, the communication between the second channel 114 and the second supply and discharge channel 108 is blocked. The communication between the first channel 112 and the first supply and discharge channel 106 is also blocked. In other words, when the mode valve 116 is in the second state, the channel leading to the fluid actuator 10 is independent of the supply channel 102 and discharge channel 104. The mode valve 116 is an example of a valve that can block the communication between (i) the fluid actuator 10 and (ii) the supply channel 102 and discharge channel 104.

The fluid power circuit structure 100 has a first branch channel 118, a second branch channel 120, a pilot channel 122, and a switching valve 124. The first branch channel 118 branches off from the supply channel 102. The second branch channel 120 branches off from the discharge channel 104. The first and second branch channels 118 and 120 are connected to the switching valve 124.

The pilot channel 122 is connected to the switching valve 124. The pressure in the pilot channel 122 acts on the mode valve 116. The state of the mode valve 116 is thus switched according to the pressure in the pilot channel 122. Specifically, the mode valve 116 is switched to the first state when the pressure in the pilot channel 122 is higher than a certain value. When the pressure in the pilot channel 122 is equal to or below the certain value, the mode valve 116 is switched to the second state.

The switching valve 124 can switch the state of the communication between (i) the first and second branch channels 118 and 120 and (ii) the pilot channel 122. Specifically, the switching valve 124 can be switched between a first state and a second state.

In the first state, the switching valve 124 establishes communication between the first branch channel 118 and the pilot channel 122, and blocks the second branch channel 120. Therefore, in the first state, communication is established between the supply channel 102 and the pilot channel 122. The working fluid is thus supplied from the supply channel 102 to the pilot channel 122 via the switching valve 124.

In the second state, the switching valve 124 establishes communication between the second branch channel 120 and pilot channel 122 and blocks the first branch channel 118. Therefore, in the second state, communication is established between the discharge channel 104 and the pilot channel 122. The working fluid is thus discharged from the pilot channel 122 to the discharge channel 104 via the switching valve 124.

The fluid power circuit structure 100 has a signal channel 126. The signal channel 126 supplies a fluid to the signal chamber 33 of the fluid actuator 10. The signal channel 126 is independent of the supply channel 102 and discharge channel 104. In other words, the pressure in the signal channel 126 is independent of the pressures in the supply channel 102 and discharge channel 104.

According to one example, the fluid power circuit structure 100 has a high lift device for controlling the lift of an aircraft, as the device configured to be operated by the fluid actuator 10. The high lift device is, for example, a slat attached to the leading edge of the main wing, and a flap attached to the trailing edge of the main wing.

### Fluid Actuator

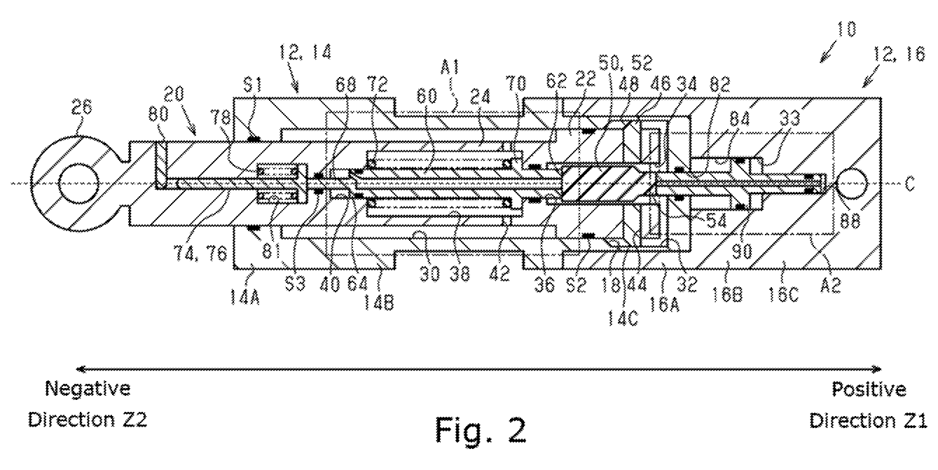

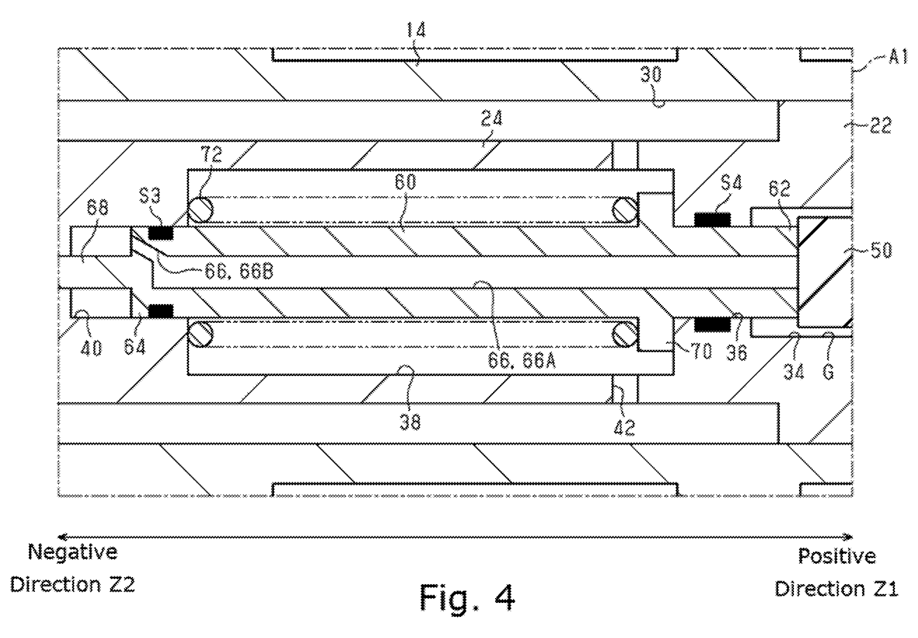

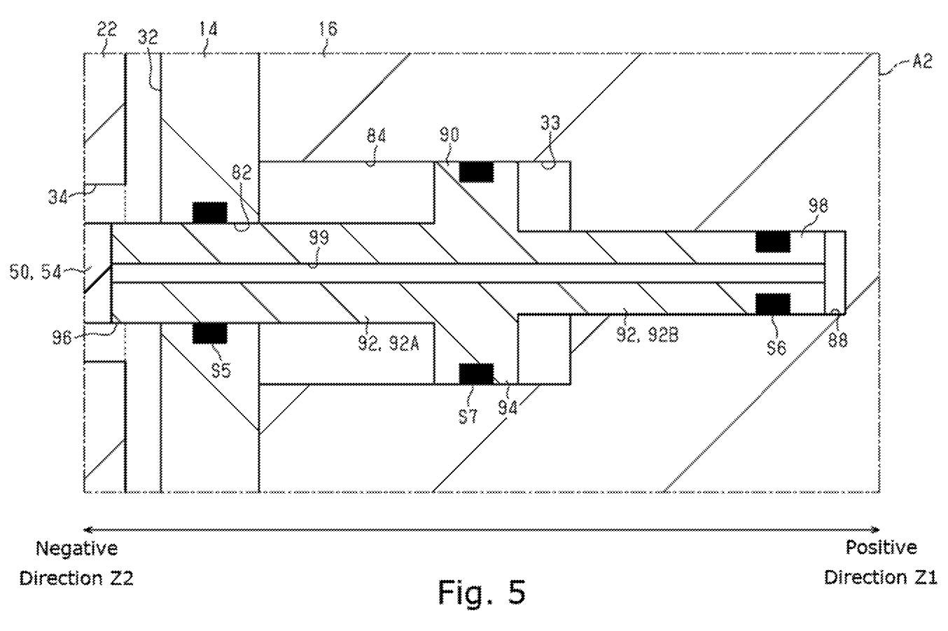

Referring to FIGS. 2 to 5, the fluid actuator 10 will be now described. FIG. 4 is an enlarged view of the area A1 defined by the dot-dash line in FIG. 2. FIG. 5 is an enlarged view of the area A2 defined by the dot-dash line in FIG. 2.

In the following description, the term “positive direction Z1” means a particular one of the directions parallel to the central axis C of the cylinder 12, and the term “negative direction Z2” means the opposite direction. Hereafter, unless otherwise explained, the term “radial direction” simply refers to the radial direction orthogonal to the central axis C. Likewise, the term “circumferential direction” simply refers to the circumferential direction centered on the central axis C.

As shown in FIG. 2, the cylinder 12 of the fluid actuator 10 is constituted by a first cylinder 14 and a second cylinder 16. The first cylinder 14 is closed at the end facing the positive direction Z1 and open at the end facing the negative direction Z2. This means that the interior space of the first cylinder 14 is defined by the bottom and side walls. The second cylinder 16 is generally positioned further in the positive direction Z1 than the first cylinder 14. The second cylinder 16 is closed at the end facing the positive direction Z1 and open at the end facing the negative direction Z2. This means that the interior space of the second cylinder 14 is defined by the bottom and side walls.

The first cylinder 14 has a small-inner-diameter portion 14A, an intermediate-inner-diameter portion 14B, and a large-inner-diameter portion 14C. The small-inner-diameter portion 14A, intermediate-inner-diameter portion 14B, and large-inner-diameter portion 14C are arranged in the stated order from the negative direction Z2 to the positive direction Z1.

The small-inner-diameter portion 14A has the opening of the first cylinder 14 facing the negative direction Z2. The inner diameter of the small-inner-diameter portion 14A is equal to the outer diameter of the piston rod 24 of the piston unit 20. Here, the term "equal" allows any tolerances as long as the fluid actuator 10 can work while the outer circumferential surface of the piston rod 24 slides relative to the inner circumferential surface of the small-inner-diameter portion 14A. The small-inner-diameter portion 14A serves as a guide for the piston unit 20 to move in a direction parallel to the central axis C. An annular seal material S1 is placed on the inner circumferential surface of the small-inner-diameter portion 14A. The seal material S1 seals the gap between the inner circumferential surface of the small-inner-diameter portion 14A and the outer circumferential surface of the piston rod 24.

The intermediate-inner-diameter portion 14B is adjacent to the small-inner-diameter portion 14A and positioned further in the positive direction Z1. The inner diameter of the intermediate-inner-diameter portion 14B is greater than that of the small-inner-diameter portion 14A. The large-inner-diameter portion 14C is adjacent to the intermediate-inner-diameter portion 14B and positioned further in the positive direction Z1. The large-inner-diameter portion 14C has the bottom wall of the first cylinder 14. The inner diameter of the large-inner-diameter portion 14C is greater than that of the intermediate-inner-diameter portion 14B. The inner circumferential surface of the intermediate-inner-diameter portion 14B is connected to the inner circumferential surface of the large-inner-diameter portion 14C via a step surface 18. The inner diameter of the step surface 18 continuously increases from the intermediate-inner-diameter portion 14B to the large-inner-diameter portion 14C.

The second cylinder 16 has a large-inner-diameter portion 16A, an intermediate-inner-diameter portion 16B, and a small-inner-diameter portion 16C. The large-inner-diameter portion 16A, intermediate-inner-diameter portion 16B, and small-inner-diameter portion 16C are arranged in the stated order from the negative direction Z2 to the positive direction Z1.

The large-inner-diameter portion 16A has the opening of the second cylinder 16 facing the negative direction Z2. The inner diameter of the large-inner-diameter portion 16A of the second cylinder 16 is equal to the outer diameter of the portion of the first cylinder 14 that is near the bottom wall. The large-inner-diameter portion 16A of the second cylinder 16 is radially externally fitted onto a portion of the first cylinder 14 that is located on the positive direction Z1 side. In other words, the portion of the first cylinder 14 that is near the bottom wall is located inside the large-inner-diameter portion 16A of the second cylinder 16. Although not shown, the first and second cylinders 14 and 16 are fixed together by bolts or other fixing members so that they are unable to move relative to each other.

The intermediate-inner-diameter portion 16B is adjacent to the large-inner-diameter portion 16A and positioned further in the positive direction Z1. The inner diameter of the intermediate-inner-diameter portion 16B is smaller than that of the large-inner-diameter portion 16A. The small-inner-diameter portion 16C is adjacent to the intermediate-inner-diameter portion 16B and positioned further in the positive direction Z1. The inner diameter of the small-inner-diameter portion 16C is smaller than that of the intermediate-inner-diameter portion 16B.

The piston unit 20 is located inside the first cylinder 14. The piston 22 divides the interior space of the first cylinder 14 into the first and second fluid chambers 30 and 32. The first fluid chamber 30 is a cylindrical space centered on the central axis C. The first fluid chamber 30 is part of the interior space of the intermediate-inner-diameter portion 14B. The second fluid chamber 32 is a cylindrical space centered on the central axis C. The second fluid chamber 32 is part of the interior space of the large-inner-diameter portion 14C. The outer diameter of the piston 22 is equal to the inner diameter of the intermediate-inner-diameter portion 14B of the first cylinder 14. An annular seal material S2 is placed on the outer circumferential surface of the piston 22. The seal material S2 seals the gap between the outer circumferential surface of the piston 22 and the inner circumferential surface of the first cylinder 14. Although not shown, the first fluid chamber 30 is connected to the first channel 112 via a port. The second fluid chamber 32 is connected to the second channel 114 via a port.

The piston unit 20 has an interior space. The interior space of the piston unit 20 is a cylindrical space centered on the central axis C. The interior space of the piston unit 20 extends from the end face of the piston 22 facing the second fluid chamber 32 and through the piston 22 and the piston rod 24. Accordingly, the end surface of the piston 22 that faces the second fluid chamber 32 has an opening.

The piston unit 20 has a third fluid chamber 34, a communicating channel 36, a fourth fluid chamber 38, and a fifth fluid chamber 40. The third fluid chamber 34, the communicating channel 36, the fourth fluid chamber 38, and the fifth fluid chamber 40 constitute the interior space of the piston unit 20. The third fluid chamber 34 is located inside the piston 22 and the piston rod 24. The communicating channel 36, the fourth fluid chamber 38, and the fifth fluid chamber 40 are located inside the piston rod 24.

The third fluid chamber 34 is a portion of the interior space of the piston unit 20 that is located at the end of the piston 22 that faces the second fluid chamber 32. The third fluid chamber 34 has the opening of the piston 22 facing the second fluid chamber 32. In other words, the third fluid chamber 34 is connected to the second fluid chamber 32. The communicating channel 36 is connected to the third fluid chamber 34. The fourth fluid chamber 38 is connected to the communicating channel 36. In other words, the communicating channel 36 connects the third and fourth fluid chambers 34 and 38. The fifth fluid chamber 40 is connected to the fourth fluid chamber 38. The third fluid chamber 34, the communicating channel 36, the fourth fluid chamber 38, and the fifth fluid chamber 40 are arranged in the stated order toward the negative direction Z2.

As shown in FIG. 4, the communicating channel 36 is closed by a locking piston 60, which will be described below. The communication between the fourth fluid chamber 38 and the fifth fluid chamber 40 is blocked by the locking piston 60. The third and fifth fluid chambers 34 and 40 are connected to each other via an internal channel 66 in the locking piston 60.

The third fluid chamber 34, the communicating channel 36, the fourth fluid chamber 38, and the fifth fluid chamber 40 are all cylindrical spaces centered on the central axis C. The inner diameter of the third fluid chamber 34 is smaller than that of the fourth fluid chamber 38. The inner diameter of the communicating channel 36 is smaller than that of the third fluid chamber 34. The inner diameter of the fifth fluid chamber 40 is equal to that of the communicating channel 36.

The fluid actuator 10 has two connecting channels 42 that connect the fourth and first fluid chambers 38 and 30. The connecting channels 42 extend through the side wall of the piston rod 24 in the radial direction. The connecting channels 42 are spaced away from each other by 180 degrees in the circumferential direction. In FIGS. 2, 3 and 4, a representative one of the connecting channels 42 is indicated by the reference numeral.

The piston unit 20 has four through holes 44 that extend through the side wall of the piston 22 in the radial direction. The through holes 44 are spaced away from each other by 90 degrees in the circumferential direction. The through holes 44 are spaces substantially shaped like a rectangular prism.

The piston unit 20 has a key lock 46 and a ram lock 50. The key lock 46 is switchable between (i) a key locked state that restricts movement of the piston unit 20 relative to the cylinder 12 and (ii) a key released state that permits movement of the piston unit 20 relative to the cylinder 12. The ram lock 50 is movable between (i) a locked position that restricts the transition of the key lock 46 from the key locked state to the key released state and (ii) a released position that permits the transition of the key lock 46 from the key locked state to the key released state.

The piston unit 20 has four key locks 46. The number of the key locks 46 corresponds to the number of the through holes 44 in the piston unit 20. The key locks 46 are respectively located within the through holes 44. The key locks 46 are shaped like a rectangular prism, corresponding to the shape of the through holes 44. The key locks 46 respectively move in the radial direction within the through holes 44. The radial dimension of each key lock 46 is greater than the radial dimension of the piston 22 from the inner circumferential surface to the outer circumferential surface.

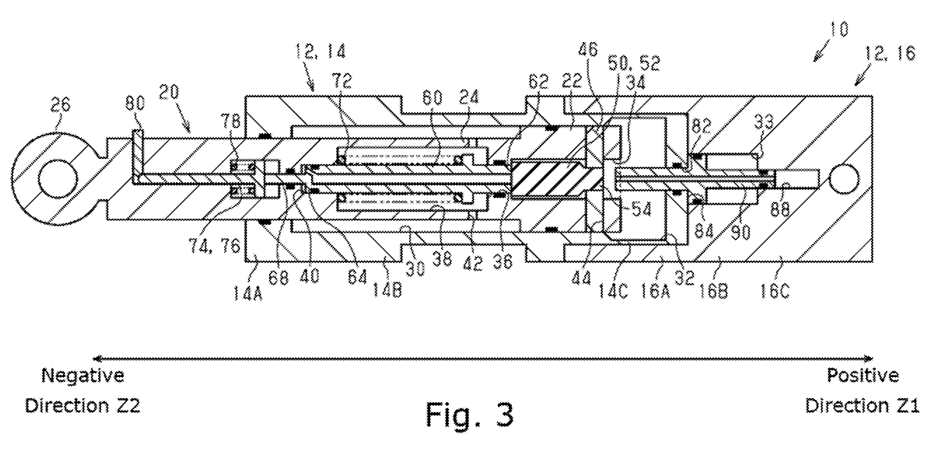

The key locks 46 can move in the radial direction outwardly, to protrude outward beyond the outer circumferential surface of the piston 22. The key locks 46 can move in the radial direction inwardly, to be entirely accommodated inside the outer circumferential surface of the piston 22. In the following description, when the key locks 46 are at a protruding position, a portion of each key lock 46 protrudes outwardly beyond the outer circumferential surface of the piston 22 as shown in FIG. 2. In contrast, as shown in FIG. 3, when the key locks 46 are at an accommodated position, each key lock 46 is entirely accommodated inside the piston 22. The key locked state described above corresponds to the key locks 46 being at the protruding position. The key released state corresponds to the key locks 46 being at the accommodated position.

Here, the inner diameter of the intermediate-inner-diameter portion 14B of the first cylinder 14 is equal to the outer diameter of the piston 22 of the piston unit 20. Accordingly, the key locks 46 are at the accommodated position when located inside the intermediate-inner-diameter portion 14B of the first cylinder 14. In other words, the key locks 46 cannot be at the protruding position when located inside the intermediate-inner-diameter portion 14B of the first cylinder 14.

The inner diameter of the large-inner-diameter portion 14C of the first cylinder 14 is greater than the outer diameter of the piston 22 of the piston unit 20. Accordingly, the key locks 46 can be at the protruding position when located inside the large-inner-diameter portion 14C of the first cylinder 14. In other words, the key locks 46 can move between the accommodated and protruding positions when located inside the large-inner-diameter portion 14C of the first cylinder 14.

While the key locks 46 are at the protruding position, the piston unit 20 may attempt to move in the direction in which the volume of the second fluid chamber 32 increases, that is, in the negative direction Z2. In this case, the key locks 46 come into contact with the step surface 18 of the first cylinder 14. Accordingly, when the key locks 46 are at the protruding position, this restricts the movement of the piston unit 20 relative to the cylinder 12. Specifically, when the key locks 46 are at the protruding position, the piston unit 20 cannot move such that the key locks 46 move through the first cylinder 14 from the large-inner-diameter portion 14C to the intermediate-inner-diameter portion 14B.

The portion of each key lock 46 that projects outwardly beyond the piston unit 20 at the protruding position has a tapered surface 48, which corresponds to the step surface 18 of the first cylinder 14. In other words, the portion of each key lock 46 that is near the piston rod 24 of the piston unit 20 is shaped such that its radial length decreases toward the piston rod 24. The tapered surface 48 of each key lock 46 is pressed against the step surface 18 of the first cylinder 14, thereby urging each key lock 46 to move from the protruding position to the accommodated position.

The ram lock 50 is located inside the third fluid chamber 34. The ram lock 50 has a large-diameter portion 52 and a small-diameter portion 54. The large-diameter portion 52 is substantially cylindrical. The outer diameter of the large-diameter portion 52 is greater than the inner diameter of the communication channel 36. The small-diameter portion 54 is adjacent to the large-diameter portion 52 and positioned further in the positive direction Z1. The small-diameter portion 54 is substantially cylindrical. The outer diameter of the small-diameter portion 54 is smaller than the outer diameter of the large-diameter portion 52. A portion of the outer circumferential surface of the large-diameter portion 52 that is positioned further in the positive direction Z1 has an inclined surface sloped with respect to the central axis C. Specifically, the inclined surface is sloped such that it approaches the central axis C toward the positive direction Z1. The large-diameter portion 52 and the small-diameter portion 54 constitute one piece.

The pressure-sensitive surface of the ram lock 50 that faces the positive direction Z1 opposes the second fluid chamber 32, and the pressure-sensitive surface of the ram lock 50 that faces the negative direction Z2 opposes the third fluid chamber 34. More specifically, the pressure-sensitive surface of the ram lock 50 that faces the positive direction Z1 is exposed to the second fluid chamber 32 via the third fluid chamber 34. The pressure-sensitive surface of the ram lock 50 that faces the negative direction Z2 opposes the third fluid chamber 34. In the present embodiment, the pressure-sensitive surface of the ram lock 50 that faces the negative direction Z2 is directly exposed to the third fluid chamber 34.

The ram lock 50 is movable through the third fluid chamber 34 in a direction parallel to the central axis C. Specifically, the ram lock 50 is movable in a direction parallel to the central axis C between (i) a locked position where the large-diameter portion 52 is aligned with the key locks 46 and (ii) a released position where the small-diameter portion 54 is aligned with the key locks 46. The direction of the movement of the ram lock 50 between the locked and released positions coincides with a direction parallel to the central axis C.

As shown in FIG. 2, when the ram lock 50 is at the locked position, the large-diameter portion 52 of the ram lock 50 is located radially inward of the key locks 46. The sum of the radial dimension of each key lock 46 and the radius of the large-diameter portion 52 of the ram lock 50 exceeds the radius of the piston 22 of the piston unit 20. Therefore, when the ram lock 50 is at the locked position, the key locks 46 cannot be at the accommodated position. In other words, when the ram lock 50 is at the locked position, the key locks 46 cannot move from the protruding position to the accommodated position.

As shown in FIG. 3, when the ram lock 50 is at the released position, the small-diameter portion 54 of the ram lock 50 is located radially inward of the key locks 46. The sum of the radial dimension of each key lock 46 and the radius of the small-diameter portion 54 of the ram lock 50 falls below the radius of the piston 22 of the piston unit 20. Therefore, when the ram lock 50 is at the released position, the key locks 46 can be at the accommodated position. In other words, while being at the released position, the ram lock 50 can move between the protruding and accommodated positions.

The outer diameter of the large-diameter portion 52 is slightly smaller than the inner diameter of the third fluid chamber 34. Therefore, a gap G is left between the outer circumferential surface of the ram lock 50 and the inner circumferential surface of the third fluid chamber 34. In other words, no seal member is provided that seals between the outer circumferential surface of the ram lock 50 and the inner circumferential surface of the third fluid chamber 34. The gap G is sized such that the working fluid can flow through it. Therefore, the portion of the third fluid chamber 34 that is located further than the large-diameter portion 52 of the ram lock 50 in the negative direction Z2 is connected, via the gap G, to the portion of the third fluid chamber 34 that is located further than the large-diameter portion 52 of the ram lock 50 in the positive direction Z1. The portion of the third fluid chamber 34 that is located further than the large-diameter portion 52 of the ram lock 50 in the positive direction Z1 is connected, via the opening of the piston 22, to the second fluid chamber 32. Through the gap G, the working fluid can flow between the second fluid chamber 32 and the third fluid chamber 34. In other words, the pressures in the second and third fluid chambers 32 and 34 are equal.

### Locking Piston

As shown in FIG. 2, the fluid actuator 10 has the locking piston 60, a protrusion 68, and a flange 70. The locking piston 60 is generally rod-shaped. The locking piston 60 is located in the interior space of the piston unit 20. The locking piston 60 is located further than the ram lock 50 in the negative direction Z2. The locking piston 60 can push the ram lock 50 from the released position toward the locked position. The central axis of the locking piston 60 coincides with the central axis C of the cylinder 12.

The locking piston 60 extends from the third fluid chamber 34, through the communicating channel 36 and the fourth fluid chamber 38, and to the fifth fluid chamber 40. The outer diameter of the locking piston 60 is equal to the inner diameter of the communicating channel 36. The locking piston 60 is inserted into the communicating channel 36. The locking piston 60 closes the communicating channel 36. In other words, by closing the communicating channel 36, the locking piston 60 blocks the communication between the third fluid chamber 34 and the fourth fluid chamber 38. The outer diameter of the locking piston 60 is equal to the inner diameter of the fifth fluid chamber 40. Accordingly, the locking piston 60 blocks the communication between the fifth fluid chamber 40 and the fourth fluid chamber 38.

As shown in FIG. 4, the locking piston 60 has a first end 62 and a second end 64. The first end 62 is the end of the locking piston 60 that faces the positive direction Z1. The first end 62 opposes the ram lock 50. The first end 62 can come into contact with the ram lock 50 as the locking piston 60 moves toward the positive direction Z1. The first end 62 is located inside the third fluid chamber 34. The second end 64 is the end of the locking piston 60 that faces the negative direction Z2. The second end 64 is located inside the fifth fluid chamber 40. The protrusion 68 protrudes from the second end 64 of the locking piston 60 toward the negative direction Z2. The protrusion 68 is an integral part of the locking piston 60.

The locking piston 60 has the internal channel 66 therein that establishes communication between the third and fifth fluid chambers 34 and 40. Stated differently, the internal channel 66 connects the space where the first end 62 of the locking piston 60 is exposed, to the space where the second end 64 of the locking piston 60 is exposed.

The internal channel 66 includes a main channel 66A and an auxiliary channel 66B. The main channel 66A extends from its opening facing the first end 62 toward the second end 64 of the locking piston 60. The main channel 66A is a cylindrical space centered on the central axis C. The auxiliary channel 66B extends in the locking piston 60 from the main channel 66A to the second end 64 and opens onto the fifth fluid chamber 40. The inner diameter of the auxiliary channel 66B is smaller than that of the main channel 66A.

An annular seal material S3 is placed on the outer circumferential surface of the locking piston 60 at a site near the second end 64. The seal material S3 seals the gap between the outer circumferential surface of the locking piston 60 and the inner circumferential surface of the fifth fluid chamber 40. An annular seal material S4 is placed on the inner circumferential surface of the communication channel 36. The seal material S4 seals the gap between the inner circumferential surface of the communication channel 36 and the outer circumferential surface of the locking piston 60.

The flange 70 extends outwardly from the outer circumferential surface of the locking piston 60. The flange 70 is located further in the positive direction Z1 than the middle of the locking piston 60. The flange 70 is in contact with a spring 72, which will be described below. The outer diameter of the flange 70 is smaller than the inner diameter of the fourth fluid chamber 38. The outer diameter of the flange 70 is greater than the inner diameter of the communication channel 36. The flange 70 thus restricts the movement of the locking piston 60 toward the ram lock 50 beyond a certain range. The flange 70 is an integral part of the locking piston 60.

The fluid actuator 10 has a spring 72. The spring 72 is a coil spring. The spring 72 is provided in the fourth fluid chamber 38 and positioned further in the negative direction Z2 than the flange 70. The spring 72 biases the locking piston 60 toward the ram lock 50, i.e., toward the positive direction Z1. Specifically, the spring 72 biases the flange 70 of the locking piston 60 toward the positive direction Z1, which results in biasing the locking piston 60. The spring 72 biases the locking piston 60 toward the positive direction Z1 even when the locking piston 60 is positioned the furthest in the positive position Z1 within the movable range. The inner diameter of the spring 72 is greater than the outer diameter of the locking piston 60. The spring 72 radially externally surrounds the locking piston 60.

As shown in FIG. 2, the piston unit 20 includes an indicator assembly 74. The indicator assembly 74 contributes to determining whether the ram lock 50 is at the locked or released position.

The indicator assembly 74 has an indicator piston 76, an indicator spring 78, and an indicator 80. The indicator piston 76 and the indicator spring 78 are disposed in the space 81 defined in the piston unit 20. The space 81 is located further in the negative direction Z2 than the fifth fluid chamber 40. The indicator piston 76 and indicator spring 78 are located inside the space 81. Therefore, the indicator piston 76 and the indicator spring 78 are located further in the negative direction Z2 than the locking piston 60. The indicator piston 76 is constituted by: a piston portion that divides the space 81 into two sections next to each other in a direction along the central axis C; and a rod portion that extends from the piston portion toward the negative direction Z2.

The indicator spring 78 is disposed in the space 81 and located further in the negative direction Z2 than the piston portion of the indicator piston 76. Therefore, the indicator spring 78 biases the indicator piston 76 toward the positive direction Z1. The force exerted by the indicator spring 78 on the indicator piston 76 is sufficiently smaller than the force exerted by the spring 72 on the locking piston 60. The indicator assembly 74 thus has a negligible effect on the movement of the ram lock 50. The indicator 80 extends in the radial direction within the piston unit 20.

As shown in FIG. 3, when the locking piston 60 moves away from the ram lock 50, i.e., toward the negative direction Z2, the indicator piston 76 is pushed toward the negative direction Z2 by the protrusion 68 of the locking piston 60. In this case, the end of the rod portion of the indicator piston 76 comes into contact with the indicator 80. The indicator 80 is thus pushed upwards by the rod portion of the indicator piston 76, thereby moving in a direction that intersects the direction in which the locking piston 60 moves. In the present embodiment, the indicator 80 moves outwardly in the radial direction. Accordingly, when the locking piston 60 moves away from the ram lock 50, the indicator 80 protrudes beyond the outer circumferential surface of the piston unit 20. Therefore, whether the ram lock 50 is in the released state can be confirmed by checking whether the indicator 80 is positioned outside in the radial direction, either visually or with a sensor or the like, which is not shown.

### Release Unit

As shown in FIG. 2, the cylinder 12 has an interior space that is constituted by a guide channel 82, a sixth fluid chamber 84, a signal chamber 33, and a seventh fluid chamber 88. Specifically, the guide channel 82 passes through the bottom wall of the first cylinder 14 and is positioned on the central axis C. The sixth fluid chamber 84 and signal chamber 33 are part of the interior space of the intermediate-inner-diameter portion 16B of the second cylinder 16. The seventh fluid chamber 88 is part of the interior space of the small-inner-diameter portion 16C of the second cylinder 16. The guide channel 82, the sixth fluid chamber 84, the signal chamber 33, and the seventh fluid chamber 88 are all cylindrical spaces centered on the central axis C.

The guide channel 82 is connected to the second fluid chamber 32. The sixth fluid chamber 84 is connected to the guide channel 82. The signal chamber 33 is connected to the sixth fluid chamber 84. The signal chamber 33 and the sixth fluid chamber 84 are separated by a release piston 94 of a release unit 90, which will be described below. The seventh fluid chamber 88 is connected to the signal chamber 33. The guide channel 82, the sixth fluid chamber 84, the signal chamber 33, and the seventh fluid chamber 88 are arranged in the stated order toward the positive direction Z1. The inner diameter of the guide channel 82 is smaller than that of the sixth fluid chamber 84. The inner diameter of the sixth fluid chamber 84 is equal to that of the signal chamber 33. The inner diameter of the seventh fluid chamber 88 is smaller than that of the guide channel 82.

Although not shown, the sixth fluid chamber 84 is connected to the outside of the cylinder 12. Accordingly, the pressure in the sixth fluid chamber 84 is maintained at the atmospheric pressure. In other words, the sixth fluid chamber 84 does not constitute the fluid power circuit structure 100 through which the working fluid of the fluid actuator 10 flows.

As shown in FIG. 2, the fluid actuator 10 has a release unit 90. The release unit 90 is positioned further in the positive direction Z1 than the ram lock 50. Specifically, the release unit 90 extends from the second fluid chamber 32, through the guide channel 82, the sixth fluid chamber 84 and the signal chamber 33, and into the seventh fluid chamber 88. The release unit 90 can push the ram lock 50 from the locked position toward the released position. The central axis of the release unit 90 coincides with the central axis C of the cylinder 12.

As shown in FIG. 5, the release unit 90 has a release rod 92 and a release piston 94. The release rod 92 extends in a direction parallel to the central axis C. The release piston 94 extends outwardly from the outer circumferential surface of the release rod 92. The release piston 94 is located near the middle of the release rod 92 in a direction parallel to the central axis C.

The release rod 92 has a first portion 92A and a second portion 92B. The first portion 92A is the portion of the release rod 92 that is nearer the second fluid chamber 32 than the release piston 94. The second portion 92B is the portion of the release rod 92 that is nearer the seventh fluid chamber 88 than the release piston 94.

The first portion 92A of the release rod 92 is inserted into the guide channel 82. The outer diameter of the first portion 92A of the release rod 92 is equal to the inner diameter of the guide channel 82. Accordingly, the release rod 92 closes the guide channel 82. In other words, the release rod 92 closes the guide channel 82, thereby blocking the communication between the second fluid chamber 32 and the sixth fluid chamber 84. A seal material S5 is placed on the inner circumferential surface of the guide channel 82. The seal material S5 seals the gap between the inner circumferential surface of the guide channel 82 and the outer circumferential surface of release rod 92.

The second portion 92B of the release rod 92 is inserted into the seventh fluid chamber 88. The outer diameter of the second portion 92B of the release rod 92 is equal to the inner diameter of the seventh fluid chamber 88. Accordingly, the release rod 92 blocks the communication between the seventh fluid chamber 88 and the signal chamber 33.

An annular seal material S6 is placed on the outer circumferential surface of the second portion 92B of the release rod 92. The seal material S6 seals the gap between the outer circumferential surface of the release rod 92 and the inner circumferential surface of the seventh fluid chamber 88.

The outer diameter of the first portion 92A is greater than that of the second portion 92B. Specifically, the outer diameter of the first portion 92A is greater than that of the second portion 92B, corresponding to the fact that the inner diameter of the guide channel 82 is greater than that of the seventh fluid chamber 88.

The outer diameter of the release piston 94 is equal to the inner diameter of the sixth fluid chamber 84 and the inner diameter of the signal chamber 33. The release piston 94 separates the sixth fluid chamber 84 and the signal chamber 33. In other words, the release piston 94 blocks the communication between the sixth fluid chamber 84 and the signal chamber 33.

The release piston 94 is biased toward the ram lock 50, i.e., the negative direction Z2, by the force exerted by the pressure in the signal chamber 33. An annular seal material S7 is placed on the outer circumferential surface of the release piston 94. The seal material S7 seals the gap between (i) the outer circumferential surface of the release piston 94 and (i) the inner circumferential surfaces of the sixth fluid chamber 84 and the signal chamber 33.

The release unit 90 has a first end 96 and a second end 98. The first end 96 is the end of the release unit 90 that faces the negative direction Z2. The second end 98 is the end of the release unit 90 that faces the positive direction Z1. Specifically, the end of the release rod 92 that is located inside the second fluid chamber 32 is the first end 96. The end of the release rod 92 that is located inside the seventh fluid chamber 88 is the second end 98.

The release unit 90 has an internal channel 99 connecting the second and seventh fluid chambers 32 and 88. Stated differently, the space where the first end 96 of the release unit 90 is exposed is connected to the space where the second end 98 of the release unit 90 is exposed. The internal channel 99 of the release unit 90 is located along the central axis C. The internal channel 99 of the release unit 90 passes through the release rod 92.

### How Embodiment Works

The following now describes how the present embodiment works. As shown in FIG. 4, the first end 62 of the locking piston 60 is exposed to the third fluid chamber 34. Accordingly, the locking piston 60 is biased away from the ram lock 50 by the working fluid in the third fluid chamber 34. As the force acting to bias the locking piston 60 away from the ram lock 50 increases, the force acting to move the ram lock 50 from the released position to the locked position decreases.

Now, in contrast to the above embodiment, assume a configuration where the force counteracting the rising pressure in the third fluid chamber 34 does not increase correspondingly with the pressure rise in the third fluid chamber 34. In this case, the locking piston 60 is not able to resist the force acting to bias it away from the ram lock 50. The ram lock 50 thus tends to move to the released position. If the ram lock 50 moves to the released position, the key locks 46 are allowed to transition from the key locked state to the key released state. When the key locks 46 are in the key released state, the piston 22 is no longer fixed. In other words, as the pressure in the third fluid chamber 34 increases, the fixed piston 22 may be unintentionally released.

The third fluid chamber 34 is connected to the second fluid chamber 32. Therefore, as the pressure in the second fluid chamber 32 increases, the force acting to move the locking piston 60 away from the ram lock 50 increases. Here, the pressure in the second fluid chamber 32 may increase in cases other than when the working fluid is supplied to the second fluid chamber 32 through the supply channel 102. Specifically, the pressure increase can occur due to a change in temperature or application of an external force while the communication between (i) the second fluid chamber 32 and (ii) the supply channel 102 and discharge channel 104 is blocked.

In one example, in the fluid power circuit structure 100 shown in FIG. 1, when the supply and discharge valve 110 is closed, the communication between (i) the supply channel 102 and discharge channel 104 and (ii) the fluid actuator 10 is blocked. Therefore, the communication between (i) the second fluid chamber 32 and (ii) the supply channel 102 and discharge channel 104 is blocked. In another example, when the mode valve 116 is in the second state, the communication between (i) the supply channel 102 and discharge channel 104 and (ii) the fluid actuator 10 is blocked. Accordingly, the communication between (i) the second fluid chamber 32 and (ii) the supply channel 102 and discharge channel 104 is blocked. When the temperature of the working fluid in the second fluid chamber 32 rises with the communication between (i) the second fluid chamber 32 and (ii) the supply channel 102 and discharge channel 104 being blocked, the working fluid thermally expands. As a result, the pressure in the second fluid chamber 32 increases. Additionally, when an external force causes the piston unit 20 to move in the direction where the volume of the second fluid chamber 32 becomes smaller, the pressure in the second fluid chamber 32 increases.

In this regard, in the fluid actuator 10 relating to the present embodiment, the space where the first end 62 of the locking piston 60 is exposed is connected to the space where the second end 64 of the locking piston 60 is exposed. Specifically, the third fluid chamber 34, to which the first end 62 of the locking piston 60 is exposed, is connected to the fifth fluid chamber 40, to which the second end 64 of the locking piston 60 is exposed. Accordingly, an increase in the force acting to move the locking piston 60 away from the ram lock 50 is translated into an increase in the force acting to move the locking piston 60 toward the ram lock 50.

The force exerted by the working fluid in the third fluid chamber 34 to bias the locking piston 60 is expressed as the product of the cross-sectional area of the flow path in the communicating channel 36 and the pressure in the third fluid chamber 34. The force exerted by the working fluid in the fifth fluid chamber 40 to bias the locking piston 60 is expressed as the product of the cross-sectional area of the flow path in the fifth fluid chamber 40 and the pressure in the fifth fluid chamber 40.

In the present embodiment, the outer diameter of the locking piston 60, the inner diameter of the communicating channel 36, and the inner diameter of the fifth fluid chamber 40 are equal. Thus, the force acting to cause the locking piston 60 to move away from the ram lock 50 is offset by the force acting to cause the locking piston 60 to move toward the ram lock 50.

As shown in FIG. 5, the first end 96 of the release unit 90 is exposed to the second fluid chamber 32. The release unit 90 is thus biased away from the ram lock 50 by the working fluid in the second fluid chamber 32. Therefore, as the pressure in the second fluid chamber 32 increases, the force acting to move the release unit 90 away from the ram lock 50 increases. Assuming that the force opposing the increasing pressure in the second fluid chamber 32 does not rise in response to the pressure rise in the second fluid chamber 32, it would fail to counteract the force biasing the release unit 90 away from the ram lock 50.

The release unit 90 is biased toward the ram lock 50 by the pressure in the signal chamber 33. When the release unit 90 pushes the ram lock 50, the ram lock 50 moves from the locked position to the released position. Therefore, an increase in the force acting to move the release unit 90 away from the ram lock 50 is translated into an increase in the pressure in the signal chamber 33, which is required to move the ram lock 50 from the locked position to the released position.

In this regard, in the fluid actuator 10 relating to the present embodiment, the space where the first end 96 of the release unit 90 is exposed is connected to the space where the second end 98 of the release unit 90 is exposed. Specifically, the second fluid chamber 32, to which the first end 96 of the release unit 90 is exposed, is connected to the seventh fluid chamber 88, to which the second end 98 of the release unit 90 is exposed. Therefore, as the force acting to move the release unit 90 away from the ram lock 50 increases, the force acting to move the release unit 90 toward the ram lock 50 increases.

The force exerted by the working fluid in the second fluid chamber 32 to bias the release unit 90 is expressed as the product of the cross-sectional area of the flow path of the guide channel 82 and the pressure in the second fluid chamber 32. The force exerted by the working fluid in the seventh fluid chamber 88 to bias the release unit 90 is expressed as the product of the cross-sectional area of the flow path of the seventh fluid chamber 88 and the pressure in the seventh fluid chamber 88.

### Advantageous Effects of Embodiment

The present embodiment produces the following advantageous effects.
(1) Communication is established between the third fluid chamber 34 and the fifth fluid chamber 40. Accordingly, an increase in the force exerted by the working fluid in the third fluid chamber 34 to bias the locking piston 60, to which the first end 62 of the locking piston 60 is exposed, is translated into an increase in the force exerted by the working fluid in the fifth fluid chamber 40, to which the second end 64 is exposed. Thus, the piston 22 can more reliably remain at a fixed position regardless of the pressure of the working fluid in the fluid actuator 10. The second and third fluid chambers 32 and 34 are connected. Accordingly, the piston 22 can more reliably remain at a fixed position regardless of the pressure of the working fluid in the second fluid chamber 32.
(2) Communication is established between the third and fifth fluid chambers 34 and 40 via the internal channel 66 in the locking piston 60. Therefore, the third and fifth fluid chambers 34 and 40 are connected by means of a simple structure without requiring a new channel in a separate component different from the locking piston 60.
(3) The outer diameter of the locking piston 60, the inner diameter of the communicating channel 36, and the inner diameter of the fifth fluid chamber 40 are equal. Therefore, the forces urging the locking piston 60 away from and toward the ram lock 50 counteract each other. Here, the locking piston 60 is urged toward the ram lock 50 by the spring 72. Thus, the piston 22 can more reliably remain at a fixed position regardless of the pressure of the working fluid in the fluid actuator 10.
(4) Communication is established between the second and seventh fluid chambers 32 and 88. Therefore, an increase in the force exerted by the working fluid in the second fluid chamber 32 to bias the release unit 90, to which the first end 96 is exposed, is translated into an increase in the force exerted by the working fluid in the seventh fluid chamber 88 to bias the release unit 90, to which the second end 98 is exposed. Therefore, the present embodiment can prevent an increase in the pressure in the signal chamber 33, which is required to move the ram lock 50 from the locked position to the released position. Thus, the piston 22 can be more reliably released from the fixed state regardless of the pressure of the working fluid in the fluid actuator 10.
(5) The internal channel 99 in the release unit 90 establishes communication between the second and seventh fluid chambers 32 and 88. Therefore, the second and seventh fluid chambers 32 and 88 are connected by means of a simple structure without requiring a new channel in a separate component different from the release unit 90.
(6) The outer diameter of the first portion 92A of the release rod 92 is greater than the outer diameter of the second portion 92B of the release rod 92. Therefore, the force exerted by the working fluid in the second fluid chamber 32 to bias the release unit 90 tends to be greater than the force exerted by the working fluid in the seventh fluid chamber 88 to bias the release unit 90. Thus, the piston 22 can more reliably remain at a fixed position regardless of the pressure of the working fluid in the fluid actuator 10.
(7) The indicator 80 moves in conjunction with the locking piston 60. The indicator 80 makes it easy to determine whether the ram lock 50 is at the released position.
(8) In the fluid power circuit structure 100, when the supply and discharge valve 110 is switched to the closed state, the communication between (i) the supply channel 102 and discharge channel 104 and (ii) the fluid actuator 10 is blocked. When the mode valve 116 is switched to the second state, the communication between (i) the supply channel 102 and discharge channel 104 and (ii) the fluid actuator 10 is blocked. When the communication is blocked between (i) the supply channel 102 and discharge channel 104 and (ii) the fluid actuator 10, the pressure in the second fluid chamber 32 may rise, as described above. In this regard, in the fluid actuator 10 relating to the present embodiment, the force exerted by the pressure in the second fluid chamber 32 to bias the ram lock 50 is offset by the force exerted by the pressure in the fifth fluid chamber 40 to bias the ram lock 50, as described above. Therefore, the fluid actuator 10 described above can be suitably applied to the fluid power circuit structure 100 relating to the above embodiment.

### Modification Examples

The above embodiment can be modified as described below. The embodiment and one or more of the following modification examples may be implemented in combination with one another to the extent that they are not technically inconsistent.

The fluid power circuit structure 100 can be configured without the switching valve 124. In this case, the state of the mode valve 116 may be changed by the pilot pressure. Alternatively, the mode valve 116 may be configured as a solenoid valve that switches states in response to being energized or de-energized.

In the embodiment, when the mode valve 116 is in the second state, communication is established via an orifice between the first and second channels 112 and 114. The embodiment can be differently configured. In one example, when the mode valve 116 is in the second state, the first and second channels 112 and 114 may be closed. Any configurations are acceptable as long as communication is blocked between the second channel 114 and the first and second supply and discharge channels 106 and 108 while the mode value 116 is in the second state.

The signal channel 126 may be connected to the supply channel 102. A check valve may be provided between the supply channel 102 and the signal channel 126 to block the flow of the fluid. A pressure regulator may be provided between the supply channel 102 and the signal channel 126 to change the pressure of the fluid.

The fluid actuator 10 may be applied to any other circuit structures than the fluid power circuit structure 100 described above. The fluid actuator 10 relating to the foregoing embodiment can be applied to any circuit structures as long as they can supply and discharge a working fluid to and from the first and second fluid chambers 30 and 32 of the fluid actuator 10.

The cylinder 12 can have any other suitable shape. The first and second cylinders 14 and 16 may constitute one piece. The cylinder 12 can be configured in any manner as long as it has therein the first and second fluid chambers 30 and 32. The respective fluid chambers can also have any other suitable shape.

The fluid actuator 10 can be configured without either the locking piston 60 or the release unit 90. When the liquid actuator 10 includes the locking piston 60, the piston unit 20 can be configured in any manner as long as it has therein the space where the first end 62 of the locking piston 60 is exposed and the space where the second end 64 of the locking piston 60 is exposed. When the liquid actuator 10 includes the release unit 90, the cylinder 12 can be configured in any manner as long as it has therein the space where the first end 96 of the release unit 90 is exposed and the space where the second end 98 of the release unit 90 is exposed.

The locking piston 60 can have any other suitable shape. The locking piston 60 does not necessarily have the internal channel 66. This configuration is acceptable as long as the space where the first end 62 of the locking piston 60 is exposed is connected to the space where the second end 64 of the locking piston 60 is exposed via, for example, a channel in the piston rod 24. The locking piston 60 can be configured in any manner as long as it can push the ram lock 50 from the released position to the locked position.

The piston unit 20 can have any other suitable shape. The piston 22 of the piston unit 20 may have any other suitable shape corresponding to the shapes of the respective fluid chambers of the cylinder 12. The piston unit 20 can be configured in any manner as long as it can separate the first and second fluid chambers 30 and 32.

The outer diameter of the locking piston 60, the inner diameter of the communicating channel 36, and the inner diameter of the fifth fluid chamber 40 can be set as desired. In one example, the inner diameter of the communicating channel 36 may be greater than that of the fifth fluid chamber 40. In this case, the force exerted by the working fluid in the third fluid chamber 34 to bias the locking piston 60 is greater than the force exerted by the working fluid in the fifth fluid chamber 40 to bias the locking piston 60. Thus, the piston 22 can be more reliably released from the fixed state. The inner diameter of the communicating channel 36 can be increased to the extent that unintended unlocking is prevented. In another example, the inner diameter of the communicating channel 36 may be smaller than the inner diameter of the fifth fluid chamber 40. In this case, the force exerted by the working fluid in the third fluid chamber 34 to bias the locking piston 60 is less than the force exerted by the working fluid in the fifth fluid chamber 40 to bias the locking piston 60. Thus, the piston 22 can more reliably remain at a fixed position.

The spring 72 can be arranged at other suitable positions. In one example, the spring 72 may be located in the fifth fluid chamber 40. The spring 72 is simply required to be positioned to bias the locking piston 60 toward the ram lock 50. The fluid actuator 10 can be configured without the spring 72. The fluid actuator 10 can be configured in any manner as long as the locking piston 60 is biased toward the ram lock 50 by a force independent of the pressure of the working fluid.

The release unit 90 can have any other suitable shape. The release unit 90 may be configured without the internal channel 99. In this case, the space where the first end 96 of the release unit 90 is exposed may be connected to the space where the second end 98 of the release unit 90 is exposed via, for example, a channel in the second cylinder 16. The outer diameter of the first portion 92A of the release rod 92 may be equal to the outer diameter of the second portion 92B of the release rod 92. The outer diameter of the first portion 92A of the release rod 92 may be smaller than the outer diameter of the second portion 92B of the release rod 92.

The indicator 80 can have any other suitable shape. In addition, the indicator 80 can be placed at any other position. In one example, the indicator 80 may be positioned further in the positive direction Z1 than the release unit 90. The indicator 80 may move in conjunction with the release unit 90. Depending on the position of the indicator 80, the other components of the indicator assembly 74 can be configured in any other suitable manners and placed at any other suitable positions. The indicator 80 is simply required to contribute to determining whether the ram lock 50 is at the released position. The fluid actuator 10 can be configured without the indicator 80.

The step surface 18 of the first cylinder 14 may not be necessarily tapered. Similarly, the key locks 46 may not necessarily have the tapered surfaces 48. The number and shape of the through holes 44 in the piston unit 20 can be changed as needed. The piston unit 20 is simply required to have at least one through hole 44. The number and shape of the key locks 46 can be changed according to the number and shape of the through holes 44.

The connecting channels 42 can have any other suitable shape. The connecting channels 42 can be configured in any other manner as long as they connect the first and fourth fluid chambers 30 and 38. The gap G may not be necessarily left between the inner circumferential surface of the third fluid chamber 34 and the outer circumferential surface of the ram lock 50. Any other configuration is possible as long as the pressure in the second fluid chamber 32 is equal to the pressure in the third fluid chamber 34. In one example, the second and third fluid chambers 32 and 34 may be connected via a hole extending through the ram lock 50. In another example, the piston 22 of the piston unit 20 may have a channel defined inside that can connect the second and third fluid chambers 32 and 34.

The fourth fluid chamber 38 may not be necessarily connected to the first fluid chamber 30. In other words, the pressure in the fourth fluid chamber 38 that bias the locking piston 60 may be independent of the pressure of the first fluid chamber 30.

The foregoing embodiment describes a plurality of physically separate constituent parts. They may be combined into a single part, and any one of them may be divided into a plurality of physically separate constituent parts. Irrespective of whether or not the constituent parts are integrated, they are acceptable as long as they are configured to solve the problems.

The foregoing description is merely illustrative. In addition to the components and methods (manufacturing processes) described for the purpose of describing the technology of the present disclosure, numerous possible combinations and substitutions will be apparent to the person skilled in the art. The present disclosure is intended to encompass all alternatives, variations, and modifications within the scope of the disclosure, including the claims.

What is claimed is:

1. A fluid actuator comprising:
a piston unit provided in a cylinder to divide an interior space of the cylinder into a first fluid chamber and a second fluid chamber;
a key lock configured to be switched between (i) a key locked state where movement of the piston unit relative to the cylinder is restricted and (ii) a key released state where the movement of the piston unit relative to the cylinder is allowed;
a ram lock configured to move between (i) a locked position where transition of the key lock from the key locked state to the key released state is restricted and (ii) a released position where the transition of the key lock from the key locked state to the key released state is allowed; and
a locking piston provided in an interior space of the piston unit, the locking piston being configured to push the ram lock from the released position to the locked position,
wherein a space where a first end of the locking piston is exposed is connected to a space where a second end of the locking piston is exposed.

2. The fluid actuator of claim 1,
wherein the interior space of the piston unit has: a third fluid chamber connected to the second fluid chamber; a fourth fluid chamber connected to the first fluid chamber; a fifth fluid chamber connected to the third fluid chamber; and a communicating channel connecting the third and fourth fluid chambers,
wherein, when a positive direction refers to a specific direction parallel to a central axis of the piston unit and a negative direction is opposite to the positive direction, the third fluid chamber, the communicating channel, the fourth fluid chamber, and the fifth fluid chamber are arranged in a stated order toward the negative direction,
wherein the ram lock is located inside the third fluid chamber, and
wherein the locking piston is inserted into and closes the communicating channel, and the locking piston has an internal channel that establishes communication between the third and fifth fluid chambers.

3. The fluid actuator of claim 2, comprising
a spring provided in the fourth fluid chamber, the spring biasing the locking piston toward the positive direction,
wherein an outer diameter of the locking piston, an inner diameter of the communicating channel, and an inner diameter of the fifth fluid chamber are equal.

4. A fluid actuator comprising:
a piston unit provided in a cylinder to divide an interior space of the cylinder into a first fluid chamber and a second fluid chamber;
a key lock configured to be switched between (i) a key locked state where movement of the piston unit relative to the cylinder is restricted and (ii) a key released state where the movement of the piston unit relative to the cylinder is allowed;
a ram lock configured to move between (i) a locked position where transition of the key lock from the key locked state to the key released state is restricted and (ii) a released position where the transition of the key lock from the key locked state to the key released state is allowed; and
a release unit configured to push the ram lock from the locked position toward the released position, and
wherein a space where a first end of the release unit is exposed is connected to a space where a second end of the release unit is exposed.

5. The fluid actuator of claim 4,
wherein the cylinder has:
a guide channel connected to the second fluid chamber;
a sixth fluid chamber connected to the guide channel;
a signal chamber connected to the sixth fluid chamber; and
a seventh fluid chamber connected to the signal chamber, and
wherein the release unit includes:
a release rod extending from the second fluid chamber, through the guide channel, the sixth fluid chamber, and the signal chamber, and to the seventh fluid chamber, the release rod being inserted into and closing the guide channel, and the release rod having an internal channel that establishes communication between the second and seventh fluid chambers; and
a release piston projecting outward from an outer circumferential surface of the release rod, the release piston separating the sixth fluid chamber and the signal chamber.

6. The fluid actuator of claim 5,
wherein the release rod has: a first portion that is nearer the second fluid chamber than the release piston; and a second portion that is nearer the seventh fluid chamber than the release piston, and
wherein an outer diameter of the first portion is greater than an outer diameter of the second portion.

7. The fluid actuator of claim 1, comprising
an indicator configured to move, upon movement of the locking piston away from the ram lock, in a direction intersecting a direction of the movement of the locking piston, to protrude beyond an outer circumferential surface of the piston unit.

8. A fluid power circuit structure for a fluid actuator, the fluid power circuit structure comprising:
the fluid actuator of claim 1;
a supply channel through which a working fluid is supplied to the fluid actuator;
a discharge channel through which the working fluid is discharged from the fluid actuator; and
a valve configured to block communication between (i) the fluid actuator and (ii) the supply channel and the discharge channel.

9. A fluid power circuit structure for a fluid actuator, the fluid power circuit structure comprising:
the fluid actuator of claim 4;
a supply channel through which a working fluid is supplied to the fluid actuator;
a discharge channel through which the working fluid is discharged from the fluid actuator; and
a valve configured to block communication between (i) the fluid actuator and (ii) the supply channel and the discharge channel.
